(19) United States
(12) Patent Application Publication
(10) Pub. No.: US 2026/0261168 A1
(43) Pub. Date: Sep. 3, 2026

(54) STATOR FOR A ROTATING ELECTRIC MACHINE AND METHOD FOR MANUFACTURING THE SAME

(71) Applicants: AMPERE S.A.S., Boulogne-Billancourt (FR); WHYLOT, Cember (FR)

(72) Inventors: Jere KOLEHMAINEN, Cleon (FR); Sid-Ali RANDI, Guyancourt (FR)

(73) Assignees: AMPERE S.A.S, Boulogne-Billancourt (FR); WHYLOT, Cambes (FR)

(21) Appl. No.: 18/864,643

(22) PCT Filed: May 12, 2023
(86) PCT No.: PCT/FR2023/050685

§ 371 Date: Nov. 11, 2024

(30) Foreign Application Priority Data
May 12, 2022 (FR) FR2204496

(51) Int. Cl. H02K 1/16; H02K 15/027

(52) U.S. Cl. CPC H02K 1/165; H02K 15/027

(57) ABSTRACT

An electric machine stator having a stator yoke having a circular surface and a plurality of stator teeth standing on the circular surface. Each of the stator teeth including, on the one hand, a stack of plates made of grain-oriented steel, having a first end connected to the yoke and an opposite second free end and, on the other hand, an electrical wire winding, each of the plates extending according to a direction normal to the circular surface, whereas the grains are oriented parallel to the normal direction. Each of the plates is cut into a T-shape forming two lips, so that the second free end has two opposite free flanges; and each of the plates is treated so as to disorient the grains at the level of their two lips.

The present invention relates to a stator for a rotating electric machine for an electric or hybrid motor vehicle and to a method for producing such a stator.

Known rotating electric machines, so-called “axial flux” machines, comprise a rotor installed coaxially between two stators.

The rotor comprises a disk divided into identical angular sectors, and the disk has one or more compartment(s) in each of the angular sectors to receive one or more permanent magnet(s).

As regards the two stators, between which the disk rotates, each of them comprises a stator yoke having a circular receiving surface extending according to one plane and a plurality of stator teeth evenly standing at iso-distance from each other on the circular receiving surface so as to be able to coincide with the angular sectors of the rotor.

Each of the stator teeth includes a stack of grain-oriented steel plates, having a first end connected to the yoke and an opposite second free end able to face the disk of the rotor.

Each of the stator teeth comprises an electrical wire winding around the stack in order to be able to induce a magnetic field therethrough.

Also, each of said plates extends according to a direction normal to the circular receiving surface, whereas the grains are oriented substantially parallel to said normal direction.

Reference could be made to document WO 2020/078667, which describes the implementation of such a material in a rotating electric machine.

Grain-oriented steels are advantageously implemented in applications relating to rotating machines because they offer a better magnetic conductivity, specifically in the direction of orientation of the grains.

On the other hand, conversely, these materials have a strong magnetic resistance, or reluctance, when the magnetic field extends according to a direction transverse with respect to the orientation of the grains.

Also, the free end of the stacks of the stator teeth are separated from the permanent magnets of the rotor by a functional air gap, since the rotor is driven in rotational movement relative to the stator. And the performance of rotating electric machines is conditioned, in particular to the reduction of this air gap.

Also, a problem that arises and that the present invention aims to solve is to provide a stator enabling a reduction of this air gap without interfering with the other elements already allowing improving the performance of the machines.

In order to solve this problem, and according to a first object, a stator of a rotating electric machine for a motor vehicle is provided, comprising a stator yoke having a circular receiving surface and a plurality of stator teeth evenly standing, at a distance from each other, on said circular surface, each of the stator teeth including, on the one hand, a stack of plates made of grain-oriented steel, having a first end connected to said yoke and an opposite second free end and, on the other hand, an electrical wire winding around said stack, each of said plates extending according to a direction normal to said circular receiving surface, whereas the grains are oriented substantially parallel to said normal direction. Each of said plates is cut into a T-shape forming two opposite lips, so that said second free end of said stack of plates has two opposite free flanges formed by the lips of the plates of said stack; and each of said plates is treated so as to disorient the grains at their two opposite lips.

Thus, one feature of the invention lies in the implementation of plates each cut into a T-shape to form the stacks and, what is more, in the local treatment of each of these plates at the level of each of the two opposite lips in order to locally disorient the grains of the steel at the level of these lips.

Indeed, the lips of the plates allow forming two opposite free flanges of the stack when they are stacked, which free flanges allow holding the electrical wire winding.

Nonetheless, the magnetic field lines that extend substantially parallel to said direction normal to the core of the stack, diverge at the level of the free end of the stacks, and tend to pass through the free flanges according to an oblique direction with respect to the normal direction.

Yet, the grains are oriented according to a direction substantially parallel to the normal direction, including in the plates at the level of the free flanges in the absence of treatment, and like the steel with poor magnetic conductivity when the magnetic field lines intersect the direction of the grains, the free flanges of the stacks offer a high reluctance and high iron losses if the orientation of the grains is not modified at this level.

And specifically, according to the invention, the grains are disoriented at the level of the lip of the plates to reduce this reluctance.

Preferably, said grains are disoriented independently of each other in random directions. In this manner, the steel locally returns into “non-oriented grains”, so that the reluctance is lowered compared to the situation where the grains are oriented substantially parallel to said normal direction.

According to a non-limiting variant, the two opposite lips of each of said plates are heat-treated to disorient said grains. By supplying thermal energy to the plates at the level of the lips, a metallurgical modification is caused which randomly redistributes the orientation of the grains.

What is more, after cutting the plates, this local energy supply is easy to implement.

According to another variant of the invention, the two opposite lips of each of said plates are folded, or folded and unfolded according to lines transverse to said lips spaced apart from each other to disorient said grains. This mechanical operation of bending and unbending the plates at the level of the lips, according to transverse lines, also allows redistributing the orientation of the grains. This bending may consist in folding the portions of lips against each other, for example by less than 90° and then unfolding them in the reverse way. In fine, the lip extends freely in the mean plane of the steel plate.

Advantageously, the transverse bend lines of the lips are substantially parallel to each other.

According to a hybrid variant of the invention, it is proceeded with both a heat treatment and a mechanical treatment.

According to still another variant, the two opposite lips of each of said plates are etched by a laser beam according to longitudinal lines oriented towards the tip of said lips and spaced apart from each other to disorient said grains. Such a technique allows easily modifying the metallurgical structure of the steel without contact. What is more, it is easy to integrate to the common production system for making plates and stacks.

It also allows obtaining a more random redistribution of the orientation of the grains in the material.

Also, said longitudinal lines are preferably substantially parallel to each other. In this manner, it is possible to obtain a locally random redistribution.

According to a particularly advantageous, yet non-limiting, implementation mode of the invention, said stator yoke is made of grain-oriented steel, and said first end of said stack and the yoke portion located in the vicinity of said first end are treated so as to disorient the grains. The stator yoke may also be made of a superposition of grain-oriented steel plates. And, at the level of the junction between the stack and said superposition of plates, the grains of the steel of the superposition extend substantially perpendicular to those of the steel of the plates of the stack. Thus, the magnetic field lines generated by the electrical wire winding around the stack, which extend parallel to the direction of the normal, then extend perpendicular to the oriented grains of the plates of the superposition forming the yoke. Consequently, the yoke locally offers a considerable reluctance at the level of said junction.

Also, in order to overcome this, the first end of the stack and the yoke portion to which it is connected are, for example, treated by means of a laser beam as will be explained in more detail hereinafter so as to randomly redistribute the orientation of the grains at the level of the junction.

In this manner, the reluctance at the level of the junction is reduced in the same way.

According to a particularly advantageous, yet non-limiting, embodiment of the invention, said stator yoke has a receiving circular surface with a cylindrical general shape. In other words, the resulting rotating electric machine is so-called “radial-flux” machine. More specifically, the rotor rotates inside the stator and the magnetic field induced through the stacks of plates extends according to a radial direction.

According to another embodiment of the invention, said stator yoke has a circular receiving surface extending according to a plane. In other words, the resulting rotating electric machine is so-called “axial-flux” machine.

According to another object, a method is provided for producing a rotating electric machine stator for a motor vehicle as described hereinabove, according to which a stator yoke having a circular receiving surface and a plurality of stator teeth evenly standing at a distance from each other on said circular surface is provided, each of the stator teeth including, on the one hand, a stack of plates made of grain-oriented steel, having a first end connected to said yoke and an opposite second free end and, on the other hand, an electrical wire winding around said stack, each of said plates extending according to a direction normal to said circular receiving surface, whereas the grains are oriented substantially parallel to said normal direction; and, each of said plates is cut into a T-shape forming two opposite lips, each of said plates is treated so as to disorient the grains at the level of their two opposite lips, so that said second free end of said stack of plates has two opposite free flanges formed by the lips of the plates of said stack.

Preferably, said grains are disoriented independently of each other in random directions.

Other features and advantages of the invention will become apparent upon reading the description made hereinafter of particular embodiments of the invention, given for indication and without limitation, with reference to the appended drawings wherein:

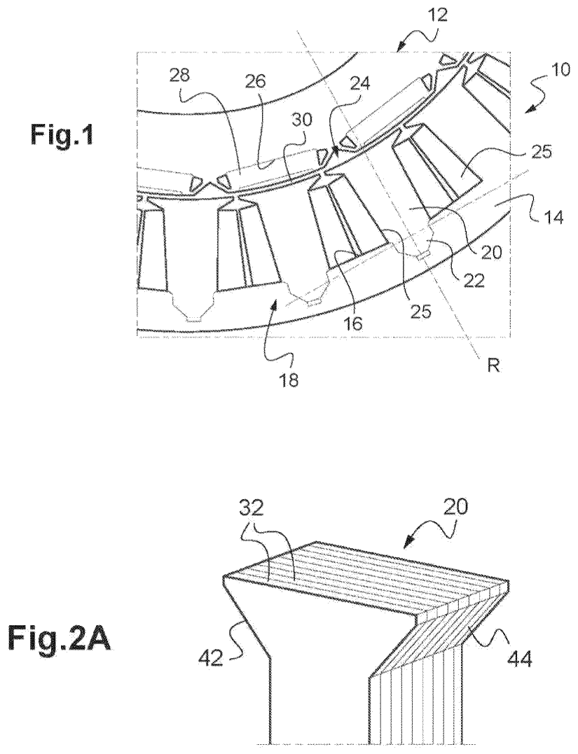

FIG. 1 is a partial schematic view in radial section of a stator in accordance with the invention according to an implementation mode;

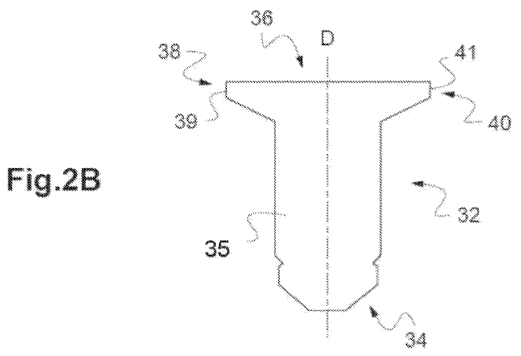

FIG. 2A is a schematic perspective detail view of FIG. 1;

FIG. 2B is a schematic front view of an element of the object of FIG. 2A;

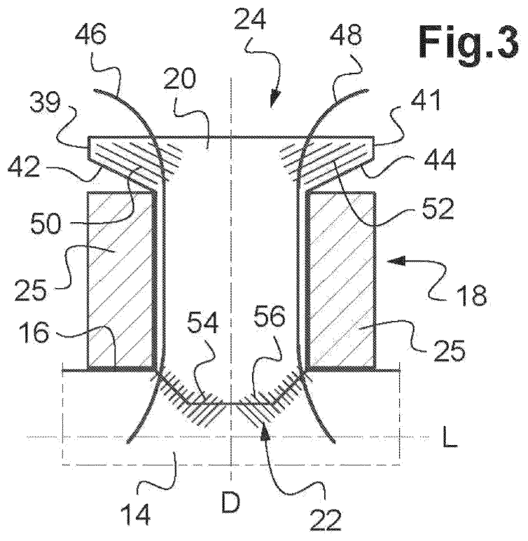

FIG. 3 is a schematic axial sectional view of an element illustrated in FIG. 1 according to one variant;

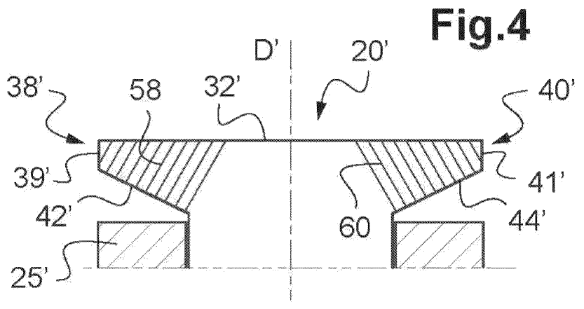

FIG. 4 is a schematic axial sectional view of an element illustrated in FIG. 1 according to another variant;

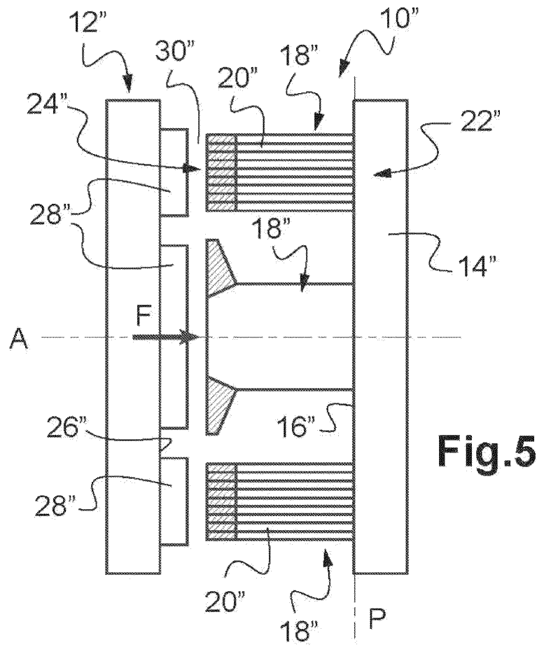

FIG. 5 is a schematic side view of a stator in accordance with the invention according to another implementation mode;

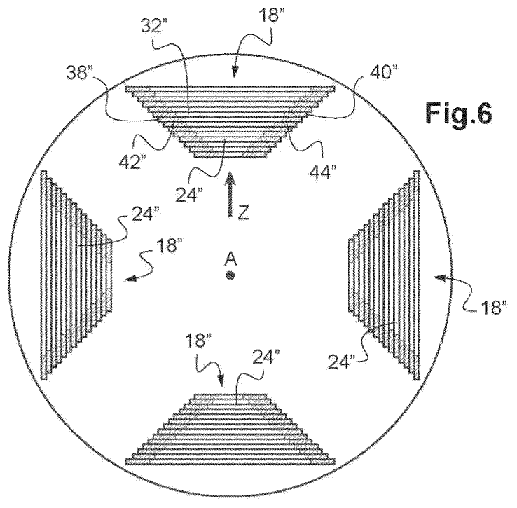

FIG. 6 is a schematic front detail view according to the arrow F of the stator illustrated in FIG. 5; and,

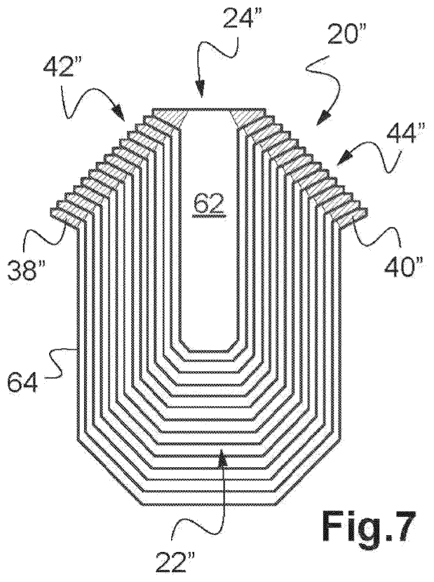

FIG. 7 is a schematic perspective bottom view of an element shown in FIG. 6 according to the arrow Z.

FIG. 1 partially shows a stator 10 inside which a rotor 12 is installed so as to be able to form a rotating electric machine. The latter is so-called “radial-flux” machine.

Thus, the stator 10 includes a stator yoke 14 having a cylindrical inner surface with a circular base 16 and a plurality of stator teeth 18 evenly standing at a distance from each other on the cylindrical surface 16.

Thus, each of the stator teeth 18 includes a stack 20 of plates made of oriented-grain steel which will be described hereinafter, which stack 20 extends radially between a first anchor end 22, anchored in the stator yoke 14 and an opposite second free end 24 extending opposite the rotor 12. In other words, each of said plates extends according to a direction normal to said circular receiving surface.

In addition, each of the stator teeth 18 comprises an electrical wire winding 25 so as to be able to induce a magnetic field through the stack 20 and extending according to a radial direction R.

The rotor 12 has a cylindrical outer surface with a circular base 26, which is provided with a plurality of permanent magnets 28 fitted at a distance from each other and evenly spaced apart.

And the space that extends between the permanent magnets 28 and the second free ends 24 of the stack 20 of the teeth 18, forms the air gap 30.

Reference is now made to FIG. 2A, FIG. 2B, FIG. 3 et FIG. 4 to describe in detail the stack 20 of grain-oriented steel plates.

Thus, the stack 20 is made from steel plates 32, cut into a T-shape in steel strips, so-called “electrical steel”, generally less than 2 mm thick. For example, these steel plates 32 are cut by punching or stamping in order to obtain them at an advantageous cost.

This type of flat metallurgical product is specially designed to obtain particular magnetic properties and in particular a high magnetic permeability.

To do so, thanks to metallurgical transformations, it is known to ensure that the grains of the steel are oriented in the same direction, specifically to obtain these particular properties.

Thus, the steel plate 32 cut into a T-shape illustrated in FIG. 2B, has a stem 35, and a root 34 and a head 36 opposite each other. And it is cut so that the crystalline structures, or grains, are aligned parallel to each other, according to a given direction D, from the root 34 to the head 36.

Also, by its T-shaped structure, the steel plate 32 has two opposite lips 38, 40, which extend laterally and end respectively in two tips 39, 41. Consequently, the grains being oriented according to the direction D, including at the level of the lips 38, 40, and thus they extend according to a transverse direction with respect to the lips 38, 40.

An object of the invention is to disorient the crystalline structures of the lips 38, 40 as will be explained hereinafter.

Thus, steel plates 32 of the type illustrated in FIG. 2B are stacked and secured against one another to form the stack 20 partially illustrated in profile view in FIG. 2A.

The steel plates 32 are coated with a varnish to electrically insulate them from each other. This known lamination technique allows reducing eddy currents through the stack 20.

Thus, the lips 38, 40 of the stacked steel plates 32 form two opposite free flanges 42, 44.

FIG. 3 shows the stack 20 anchored in the yoke 14. What is more, the electrical wire winding 25 around the stack 20 between the yoke 14 and the two opposite free flanges 42, 44 is shown.

Also, one could observe that the yoke 14 is also made of stacked grain-oriented laminations. And the grains are oriented according to a direction L perpendicular to the direction D according to which the grains of the steel plates themselves are oriented.

Moreover, when the electrical wire of the winding 25 is energised, then it induces a magnetic field at the core of the winding 20 oriented according to the direction D of the oriented grains.

On the other hand, outside the winding 25, at the level of both the first anchor end 22 and the opposite second free end 24, the magnetic field tends to diverge and the field lines, two of which 46, 48 have been partially shown for illustration, curve outwards and depart away from each other. In other words, the magnetic field, in particular in the two opposite free flanges 42, 44 is inclined with respect to the orientation of the grains. Consequently, the magnetic permeability decreases, and it is the object of the invention to overcome this.

To do so, and according to a first variant as illustrated in FIG. 3, the two opposite lips 38, 40 of each of the plates 32 are etched by means of a laser beam according to first longitudinal etching lines 50, 52 oriented towards the tip 39, 41 of the lips 38, 40. The first etching lines 50, 52 are spaced apart from each other and are preferably parallel to each other, in order to be able to homogeneously disorient said grains in the lips 38, 40.

For example, the first etching lines 50, 52 are respectively inclined by an angle comprised between 60° and 80° with respect to the original direction D of the crystalline structures.

This local treatment at the level of the lips 38, 40 of the plates 32 does not allow reorienting the grains according to another same direction, but ensuring that their orientation is randomly distributed. Consequently, fewer grains, or crystalline structures, are statistically oriented in an inclined manner with respect to the magnetic field lines 46, 48.

Thus, the magnetic permeability decreases less in comparison with a situation where the grains remain oriented according to the same original direction D. Thus, the performances of the rotating electric machine are improved.

This operation of treatment by means of a laser may be carried out on each of the steel plates 32, and each of their lips 38, 40, prior to stacking thereof.

Also, after assembly of the steel plates 32, and that of the stack 20 thus formed on the yoke 14, the first end 22 of the stack 20 and the yoke portion in which the first end 22 is anchored, are also treated so as to disorient the grains.

To do so, second etching lines 54, 56 are formed by means of a laser beam astride the first end 22 of the stack 20 and of the yoke 14. These second etching lines 54, 56 are respectively inclined substantially by 45° with respect to the direction D of orientation of the grains of the plates 32 and to the direction L of the grains of the stacked laminations of the yoke.

In this manner, the grains are locally disoriented at the level of the junction between the stack 20 and the yoke 14, randomly in order to avoid lowering the magnetic conductivity when the magnetic field tilts with respect to the orientation of the grains of the yoke 14 of the first end 22 of the stack 20.

The implementation of a laser beam is advantageous because it enables a remote local processing with no contact with the material. What is more, it can be easily industrialised on existing production lines.

According to another variant, thermal energy is supplied to the lips 38, 40 of the steel plates 32, by any means, in order to be able to disorient the crystalline structures and thus improve the magnetic conductivity.

According to still another variant, illustrated in FIG. 4, a mechanical action is exerted on the lips 38′, 40′ of the steel plates 32′. The references annotated in FIG. 4 are identical to those annotated in FIG. 3 and they are assigned a prime sign: «′», allowing distinguishing this variant from the previous one.

Thus, FIG. 4 partially shows the stack 20′ and its two opposite free flanges 42′, 44′ formed by the lips 38′, 40′ of the steel plates 32′.

According to this third variant, the two opposite lips 38′, 40′ of each of the plates 32′ of the stack 20′ are folded and unfolded respectively according to transverse fold lines 58, 60 with the lips 38′, 40′, spaced apart from each other also to disorient said grains.

For each lip 38′, 40′, the transverse fold lines 58, 60 are respectively parallel to each other. Also, the lips 38′, 40′ of each of the steel plates are folded evenly from the base up to the tip 39′, 41′.

Advantageously, the transverse fold lines 58, 60 extend in a direction inclined with respect to the orientation direction D′ of the crystalline structures of the steel plates, by an angle comprised between 20° and 45°. In this manner, a random redistribution of the orientation of the crystalline structures in the lips 38′, 40′ is obtained.

In addition, according to one variant, it is proceeded with both the heat treatment of the lips and bending thereof in order to obtain a better random distribution of the orientation of the grains.

According to another embodiment of a so-called “axial-flux” rotating electric machine, as schematically illustrated in FIG. 5, the stator 10″ includes a stator yoke 14″ having a first circular surface 16″ extending according to a plane P and a plurality of stator teeth 18″ evenly standing at a distance from each other on the circular surface 16″.

Also, each of the stator teeth 18″ includes a stack 20″ of substantially trapezoidal oriented-grain steel plates which will be described in more detail hereinafter, which stack 20″ extends radially between a first anchor end 22″, anchored in the stator yoke 14″ and an opposite second free end 24″ extending opposite the rotor 12″.

Each of the stator teeth 18″ comprises an electrical wire winding not shown for reasons relating to clarity of the drawing, so as to be able to induce a magnetic field through the stack 20″ and extending according to an axial direction A.

The rotor 12″ has a second circular surface 26, which is provided with a plurality of permanent magnets 28″ which are adjusted at a distance from each other and evenly spaced apart.

And the space that extends between the permanent magnets 28″ and the second free ends 24″ of the stack 20″ of the teeth 18″, forms the air gap 30″.

FIG. 6 shows the stator 10″ and its stator yoke 14″ on which four trapezoidal stator teeth 18″ are installed merely for illustration.

These trapezoidal stator teeth 18″ are viewed from their second free end 24″, and their two opposite free flanges 42″, 44″ could be distinguished, including the lips 38″, 40″ of the steel plates 32″ which form them, are treated to disorient their crystalline structures.

Also, one could observe that the two opposite free flanges 42″, 44″ are divergent from each other from the centre, identified by the axial direction A, outwards. In other words, the width of the steel plates 32″ forming the stack 20″ progressively decreases from the centre outwards, although the plates 32″ have the same general shape.

Thus, FIG. 7 shows one single stack 20″ with a trapezoidal section. It is made of a series of grain-oriented steel plates 32″ between a narrow first one 62 and a wide last one 64. On the other hand, the opposite lips 38″, 40″ of the intermediate plates between the first one 62 and the last one 64, extend laterally with the same amplitude and have the same shape so as to form the two divergent opposite free flanges 42″, 44″.

Also, the opposite lips 38″, 40″ of all plates have undergone a heat treatment so as to disorient the crystalline structures, or grains; the crystalline structures of the rest of the plates remaining aligned from the first anchor end 22″ to the second free end 24″.

Thus, like in the first implementation mode, the magnetic conductivity of the two divergent opposite free flanges 42″, 44″ is improved thanks to a random reorientation of the crystalline structures, or grains.

In this manner, the performances of the rotating electric machine are thereby improved.

The invention also relates to a method for producing a stator 10 of a rotating electric machine for a motor vehicle.

According to said method, a stator yoke 14 having a circular receiving surface 16 and a plurality of stator teeth 18 evenly standing at a distance from each other on the circular surface 16 is provided.

In order to make these stator teeth 18, plates 32 made of grain-oriented steel are provided, and each of the plates 32 is cut into a T-shape forming two opposite lips 38, 40. Then, each of the plates 32 is treated so as to disorient the grains at the level of their two opposite lips 38, 40.

The treatment may be performed according to the aforementioned treatment modes. Advantageously, the grains are disoriented independently of each other in random directions. In other words, the grains are no longer oriented according to a preferred direction and their orientation is randomly distributed in the lips 38, 40.

Thus, a stack of steel plates having a first end 22, opposite to a second free end 24, is formed thereby forming two opposite flanges 42, 44 formed by the lips of the plates of the stack.

Also, for each of the teeth, an electrical wire 25 is wound around the stack, each of the plates 32 then extends according to a direction normal to the circular receiving surface 16, whereas the grains of the plates are oriented substantially parallel to said normal direction, except at the level of their two opposite lips 38, 40.

1. A stator of a rotating electric machine for a motor vehicle, comprising a stator yoke having a circular receiving surface and a plurality of stator teeth evenly standing, at a distance from each other, on said circular surface, each of the stator teeth including, on the one hand, a stack of plates made of grain-oriented steel, having a first end connected to said yoke and an opposite second free end and, on the other hand, an electrical wire winding around said stack, each of said plates extending according to a direction normal to said circular receiving surface, whereas the grains are oriented substantially parallel to said normal direction;
wherein each of said plates is cut into a T-shape forming two opposite lips, so that said second free end of said stack of plates has two opposite free flanges formed by the lips of the plates of said stack;
and each of said plates is treated so as to disorient the grains at the level of their two opposite lips.

2. The stator according to claim 1, wherein said grains are disoriented independently of each other in random directions.

3. The stator according to claim 1, wherein the two opposite lips of each of said plates are heat-treated to disorient said grains.

4. The stator according to claim 1, wherein the two opposite lips of each of said plates are folded, or folded and unfolded according to lines transverse to said lips spaced apart from each other to disorient said grains.

5. The stator according to claim 4, wherein said transverse lines are substantially parallel to each other.

6. The stator according to claim 1, wherein the two opposite lips of each of said plates are etched by a laser beam according to longitudinal lines oriented towards the tip of said lips and spaced apart from each other to disorient said grains.

7. The stator according to claim 6, wherein said longitudinal lines are substantially parallel to each other.

8. The stator according to claim 1, wherein said stator yoke is made of grain-oriented steel, and said first end of said stack and the yoke portion located in the vicinity of said first end are treated so as to disorient the grains.

9. The stator according to claim 1, wherein characterised said stator yoke has a receiving circular surface with a cylindrical general shape.

10. The stator according to claim 1, wherein said stator yoke has a circular receiving surface extending according to a plane.

11. A method for producing a rotating electric machine stator for a motor vehicle according to claim 1, wherein a stator yoke having a circular receiving surface and a plurality of stator teeth evenly standing at a distance from each other on said circular surface is provided, each of the stator teeth including, on the one hand, a stack of plates made of grain-oriented steel, having a first end connected to said yoke and an opposite second free end and, on the other hand, an electrical wire winding around said stack, each of said plates extending according to a direction normal to said circular receiving surface, whereas the grains are oriented substantially parallel to said normal direction;
and each of said plates is cut into a T-shape forming two opposite lips, and each of said plates is treated so as to disorient the grains at the level of their two opposite lips so that said second free end of said stack of plates has two opposite free flanges formed by the lips of the plates of said stack.

12. The production method according to claim 11, wherein said grains are disoriented independently of each other in random directions.
